(19) United States
(12) Patent Application Publication
(10) Pub. No.: US 2018/0360076 A1
(43) Pub. Date: Dec. 20, 2018

(54) BEVERAGE WITH ENHANCED TASTE

(71) Applicant: NESTEC S.A., Vevey (CH)

(72) Inventors: Benjamin Le Reverend, Neuvecelle (FR); Beatrice Aubert, Villars-Tiercelin (CH); Jean-Baptiste Thomazo, Ivry-sur-Seine (FR)

(21) Appl. No.: 16/061,039

(22) PCT Filed: Dec. 12, 2016
(86) PCT No.: PCT/EP2016/080549

§ 371 Date: Jun. 11, 2018

(30) Foreign Application Priority Data
Dec. 14, 2015 (EP) 15199936.4

(51) Int. Cl. A23L 2/395; A23L 2/56; A23L 2/60; A23L 27/40; A23L 27/10; A47J 31/36; A23F 5/46; A23F 3/40

(52) U.S. Cl. CPC A23L 2/395; A23L 2/56; A23L 2/60; A23L 27/40; A23L 27/10; A47J 31/3623; A23V 2250/1614; A23F 3/405; A23V 2002/00; A23V 2200/08; A23V 2200/16; A23V 2250/628; A23V 2250/1582; A23F 5/465

(57) ABSTRACT

The present invention relates in general to beverages providing enhanced taste perception. In particular, the present invention concerns beverages comprising a first homogeneous portion, and a second homogeneous portion being visually the same as the first portion, wherein a tastant is present in the second portion, the tastant being essentially absent from the first portion. Further aspects of the invention are a kit for the preparation of a beverage, a process for preparing a beverage and the use of a beverage according to the invention to reduce the quantity of tastant in a beverage without adversely affecting the taste of the beverage.

### FIELD OF THE INVENTION

The present invention relates in general to beverages providing enhanced taste perception. In particular, the present invention concerns beverages comprising a first homogeneous portion, and a second homogeneous portion being visually the same as the first portion, wherein a tastant is present in the second portion, the tastant being essentially absent from the first portion. Further aspects of the invention are a kit for the preparation of a beverage, a process for preparing a beverage and the use of a beverage according to the invention to reduce the quantity of tastant in a beverage without adversely affecting the taste of the beverage.

### BACKGROUND OF THE INVENTION

There is considerable interest in being able to enhance the taste perception of tastants such as sugar (sucrose) and salt (sodium chloride) so as to provide equivalent taste impression in foods and beverages but using lower levels of addition. The World Health Organization (WHO) recommends reducing intake of salt and sugar in developed countries down to 2 g of sodium and 50 g of sugar per capita per day.

Food products containing sections with different concentrations of tastant are known. US 2007/01231430 discloses sugar confectionery containing different sections. These sections contain a different concentration of sour ingredients, leading to increasing sour intensity experience when eating the sections after each other. The eating of the confectionery is finished with an extinguisher section, in order to douse the sourness. When consuming this confectionery the consumer perceives a difference in taste between the various sections.

WO2011/003707 discloses food products having two sections which are visually the same. Both sections contain a salty tastant, but at different concentrations. Examples of solid food products are provided. The two sections are consumed in different bites with the intention that the consumer does not detect the lower saltiness in the second section, allowing for an overall reduction in the level of salt consumed. The effect relies on the second section being consumed before the “memory” effect of the first higher salt section fades. However, studies of this approach using time intensity data [Morris et al., Chemosensory perception, 2009; Busch et al, Chemical Senses, 2009] showed that human subjects noticed changes of concentration between different sips. It would be advantageous to provide an overall reduction in tastant without the consumer being able to detect different sections, or at least with a reduced perception of such differences.

There remains a need to provide products which further enhance the taste perception of tastants such as salt and sugar. It would be advantageous to provide an enhancement of tastant perception in popular product types such as beverages. In particular, there is a need to provide such products which are easy to consume.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

### SUMMARY OF THE INVENTION

An object of the present invention is to improve the state of the art and to provide an improved solution to enhance the taste perception of tastants such as salt and sugar, or at least to provide a useful alternative. The object of the present invention is achieved by the subject matter of the independent claims. The dependent claims further develop the idea of the present invention.

Accordingly, the present invention provides in a first aspect a beverage comprising a first homogeneous portion, and a second homogeneous portion being visually the same as the first portion, wherein a tastant is present in the second portion, the tastant being essentially absent from the first portion, and wherein the volume of the second portion is between 10% and 60% of the total volume of the beverage and wherein part of the first portion and part of the second portion are consumable together.

In a second aspect, the invention relates to a kit comprising a first beverage capsule and a second beverage capsule both containing a powdered beverage composition and being adapted to be functionally inserted in the brewing cavity of a food preparation machine for the preparation of a beverage, the powdered beverage contained within the second capsule comprising a tastant, said tastant being essentially absent from the powdered beverage composition of the first portion, but otherwise the two powdered beverage compositions having essentially the same composition.

A third aspect of the invention relates to a process for preparing a beverage, the process comprising (a) delivering a first beverage portion into a receptacle, (b) delivering a second beverage portion comprising a tastant into the receptacle such that the second beverage portion forms a layer on top of the first beverage portion wherein the tastant is homogeneously distributed in the second beverage portion and the tastant is essentially absent from the first beverage portion, the first beverage portions being visually the same as the second beverage portion; and wherein the ratio of the concentration of tastant in the second beverage portion to the concentration of tastant in the overall beverage is between 3:1 and 1.1:1; and wherein the volume of the second beverage portion is between 10% and 60% of the total volume of the beverage.

A still further aspect of the invention is the use of a beverage to reduce the quantity of tastant in a beverage without adversely affecting the taste of the beverage wherein the beverage comprises a first homogeneous portion, and a second homogeneous portion being visually the same as the first portion, wherein a tastant is present in the second portion, the tastant being essentially absent from the first portion, and wherein the volume of the second portion is between 10% and 60% of the total volume of the beverage and wherein part of the first portion and part of the second portion are consumable together.

It has been surprisingly found by the inventors that the overall level of salt in a single sip may be reduced without being perceivable, as long as the liquid which first reaches the tongue is high in salt. The remaining part of the sip does not need to contain any salt at all. Initial taste delivery was found to be the main driver for overall taste perception.

### BRIEF DESCRIPTION OF THE DRAWINGS

FIG. 1 is a schematic representation of the gustometer setup

FIG. 2 shows the different samples presented to assessors to compare with the reference. The dark shaded portion corresponds to the portion with [NaCl]=2%, the light shaded portion corresponds to the portion with [NaCl]=0%. The bottom REF sample contains [NaCl]=1%.

FIG. 3 shows schematically the cups presented to the assessors. The dark shaded portion corresponds to the portion with [NaCl]=1.4%, the light shaded portion corresponds to the portion with [NaCl]=0%. The reference (REF) sample contains [NaCl]=0.7%.

FIG. 4 is a plot of 2-AFC results from the gustometer (ψ P empty shapes) and layered samples (ψ_{c} filled shapes). X-axis is sodium reduction level in % and y-axis is the percentage judging the same as having more intense saltiness. The symbols are: REF-0% ▪, REF-20% ♦, REF-33% ▴, REF-47% ● and REF-67% [symbol] . The upper horizontal dashed line indicates “more intense” and the lower line “less intense”.

FIG. 5 shows the cup from the preliminary test in example 2 where the upper (Sol_20) layer had a colourant added.

### DETAILED DESCRIPTION OF THE INVENTION

Consequently the present invention relates in part to a beverage comprising a first homogeneous portion, and a second homogeneous portion being visually the same as the first portion, wherein a tastant is present in the second portion, the tastant being essentially absent from the first portion, and wherein the volume of the second portion is between 10% and 60% (for example between 15% and 50%) of the total volume of the beverage and wherein part of the first portion and part of the second portion are consumable (for example consumed) together. The beverage of the invention may be any drink, for example a drink typically consumed hot, such as tea, coffee, hot chocolate, or soup, or a drink typically consumed cold such as fruit juice, drinking yoghurt or milk. The beverage may be a non-carbonated beverage.

The phrase “visually the same” is understood to mean that first and second homogeneous portions have the same visual appearance, which relates to the colour, structure, texture, or any other obviously and directly perceivable property without tasting or smelling, such that the two portions of the beverage appear to have the same composition for observers of the beverage. The composition of the first portion may be essentially the same as the composition of the second portion apart from the concentration of tastant, for example the two portions may be identical in terms of fats, air, proteins, macronutrients and carbohydrates. For further example, the second portion may comprise the same components in the same relative proportions as in the first portion, apart from the tastant. The density of the first portion may be the same as the density of the second portion.

The tastant present in the second portion of the beverage according to the invention may be sweet, salty, bitter, umami, sour or have flavour. The tastant may comprise more than one component, for example a salty tastant may consist of potassium chloride and ammonium chloride. The ratio of the concentration of tastant in the second portion of the beverage to the overall concentration of tastant in the beverage may be between 3:1 and 1.1:1.

Part of the first portion and part of the second portion being consumable together allows a single sip to comprise liquid from the first and second beverage portions. The total volume of the part of the first portion and the part of the second portion may therefore be less than or equal to a natural sip volume. The second portion of the beverage may arranged to enter the mouth of a subject consuming the beverage before the first portion of the beverage. When liquid containing a tastant contacts the tongue before liquid without a tastant, the overall taste impression is strongly influenced by the concentration of tastant in the first liquid to encounter the tongue. In the beverage of the invention, part of the first portion and the part of the second portion may consumable together followed by another part of the first portion and another part of the second portion together. For example the beverage may be such that a part of the first portion may be consumable with a part of the second portion in a series of such combinations, for example a series of at least 3 combinations, for example a series of at least 5 combinations, for example series of at least 10 combinations. The beverage of the invention may be such that the majority of the second portion by volume is consumable in a series of combinations comprising (for example consisting of) part of the first portion and part of the second portion together.

The first and second portions in the beverage of the invention may be layers of the beverage and the second portion may be the top layer of the beverage. If such a beverage is contained in a normal cup, tilting the cup to drink the beverage will result in a quantity of the second portion entering the mouth of the subject, followed by the first portion of the beverage. This is facilitated by the second portion being between 10% and 60% of the total volume of the beverage. Other arrangements to provide sequential delivery of the two beverage portions in a single sip may be provided, for example the beverage may be packed in packaging material in which the portions are divided over different compartments. When the beverage is consumed from the packaging material directly, then the design may be such that a part of the second portion is delivered first, followed rapidly by a part of the first portion.

The tastant in the beverage of the invention may comprise sodium chloride, for example the tastant may be sodium chloride. Humans have added common salt (sodium chloride) to their food for thousands of years and have grown accustomed to its taste. As a result, the most desirable saltiness profile is that obtained with sodium chloride. Sodium chloride can act to enhance the overall flavour of the food. The beverage according to the invention may contain 140 mg of sodium or less per 100 g of the total beverage. The U.S. Food and Drug Administration define meals and main dishes to be “low in sodium” if they contain 140 mg or less of sodium per 100 g.

The tastant in the beverage of the invention may comprise sucrose, for example the tastant may be sucrose.

The beverage of the invention may be a beverage type selected from the group consisting of soups, drinking yoghurts, coffee, tea, drinking chocolates and malt beverages.

In a further aspect, the invention may be a kit comprising a first beverage capsule and a second beverage capsule, both containing a powdered beverage composition and being adapted to be functionally inserted in the brewing cavity of a food preparation machine for the preparation of a beverage, the powdered beverage contained within the second capsule comprising a tastant, said tastant being essentially absent from the powdered beverage composition of the first portion, but otherwise the two powdered beverage compositions having essentially the same composition. Single-use beverage capsules are very popular because they provide a fresh tasting beverage quickly, conveniently and in a clean fashion. The kit of the invention as described above may be used by the two capsules being sequentially injected with water to produce an instant beverage. The capsules may be served in sequence in a beverage capsule machine for example.

The first beverage capsule is generally first injected with water, followed by the second beverage capsule. The resulting beverage liquid is generally delivered into a container, such as a cup. The food preparation machine may be programmed to deliver different volumes of water for the two capsules, for example the food preparation machine may deliver a volume of water for the first capsule which is between two thirds and nine times the volume of water delivered for the second capsule.

The beverage capsules may be identifiable to enable the food preparation machine to alter the water volume for the different capsules. For example the beverage capsules may comprise an identification member. The food preparation machine may comprise reading means for reading the capsule identification member in order to read information thereof and control means connected to the reading means and designed to control the operation of the food preparation machine in response to the read information. The identification member can be of any nature, for example it may be a bar code, colour code (identified by a visual sensor), RFID tag (identified by a RF sensor), indents, cut outs, protrusions, holes (identified by a mechanical sensor), magnetic code, electronic code, induction code or conduction code. Preferably, the identification member is designed for being physically contacted from outside and is covered by a deformable, displaceable, removable and/or puncturable cover. Capsules presenting this kind of identification member are described in EP 1950 150. Generally, the machine-readable information comprises the value of the volume of water to be delivered.

The resulting beverage has two homogenous portions, the two portions being separate or only slightly mixed. The first portion is below the second portion. The second portion, on top, comprises a tastant which is essentially absent from the lower first portion. When the beverage is drunk, tilting the beverage container causes a mixture comprising part of the first portion and part of the second portion to enter the mouth of the consumer. Beverage from part of the second portion will reach the tongue of the consumer first, followed by beverage from part of the first portion. The beverage liquid initially reaching the tongue comprises a tastant and so provides a taste impact which is not diminished, or is only slightly diminished by the beverage liquid not comprising a tastant which is taken into the mouth in the same sip. The water injected into the beverage capsules may be hot or cold, depending on the beverage being prepared.

The powdered beverage composition contained within the beverage capsules comprised within the kit of the invention may be selected from the group consisting of tea, coffee, drinking chocolate or malt beverage and the tastant may be a sweet tastant. The powdered beverage composition contained within the beverage capsules comprised within the kit of the invention may be soup and the tastant may be a salty tastant.

In a further aspect, the invention provides a process for preparing a beverage, the process comprising, (a) delivering a first beverage portion into a receptacle, (b) delivering a second beverage portion comprising a tastant into the receptacle such that the second beverage portion forms a layer on top of the first beverage portion wherein the tastant is homogeneously distributed in the second beverage portion and the tastant is essentially absent from the first beverage portion, the first beverage portion being visually the same as the second beverage portion; and wherein the volume of the second beverage portion is between 10% and 60% (for example between 15 and 50%) of the total volume of the beverage. The ratio of the concentration of tastant in the second beverage portion to the concentration of tastant in the overall beverage may be between 3:1 and 1.1:1. The phrase “visually the same” is understood to mean that first and second beverage portions have the same visual appearance, which relates to the colour, structure, texture, or any other obviously and directly perceivable property without tasting or smelling, such that the two portions of the beverage appear to have the same composition for observers of the beverage. The composition of the first portion may be essentially the same as the composition of the second portion apart from the concentration of tastant, for example the two portions may be identical in terms of fats, air, proteins, macronutrients and carbohydrates. The density of the first portion may be the same as the density of the second portion.

The process of the invention may be performed by a food preparation machine, for example a beverage dispenser. The beverage dispenser may be a vending machine in which a powdery or granulated starting material for soup, coffee, tea or the like is to be mixed with hot or cold water in order to obtain a finished beverage. The first and second beverage portions in the process of the invention may be selected from the group consisting of tea, coffee, drinking chocolate and malt beverage and the tastant may be a sweet tastant. The first and second beverage portions in the process of the invention may be soup and the tastant may be a salty tastant.

The invention also provides the use of a beverage to reduce the quantity of tastant in a beverage without adversely affecting the taste of the beverage wherein the beverage comprises a first homogeneous portion, and a second homogeneous portion being visually the same as the first portion, wherein a tastant is present in the second portion, the tastant being essentially absent from the first portion, and wherein the volume of the second portion is between 10% and 60% (for example between 15% and 50%) of the total volume of the beverage and wherein part of the first portion and part of the second portion are consumable together.

In the use according to the invention, the second portion of the beverage may be arranged to enter the mouth of a subject consuming the beverage before the first portion of the beverage.

Those skilled in the art will understand that they can freely combine all features of the present invention disclosed herein. In particular, features described for the beverage of the present invention may be combined with the process of the present invention and vice versa. Further, features described for different embodiments of the present invention may be combined. Where known equivalents exist to specific features, such equivalents are incorporated as if specifically referred to in this specification. Further advantages and features of the present invention are apparent from the figures and non-limiting examples.

### EXAMPLES

### Example 1: Sensory Impact of Beverage Delivered in Two Sequences or with Two Portions, One Containing Sodium Chloride

### 1.a Materials and Methods

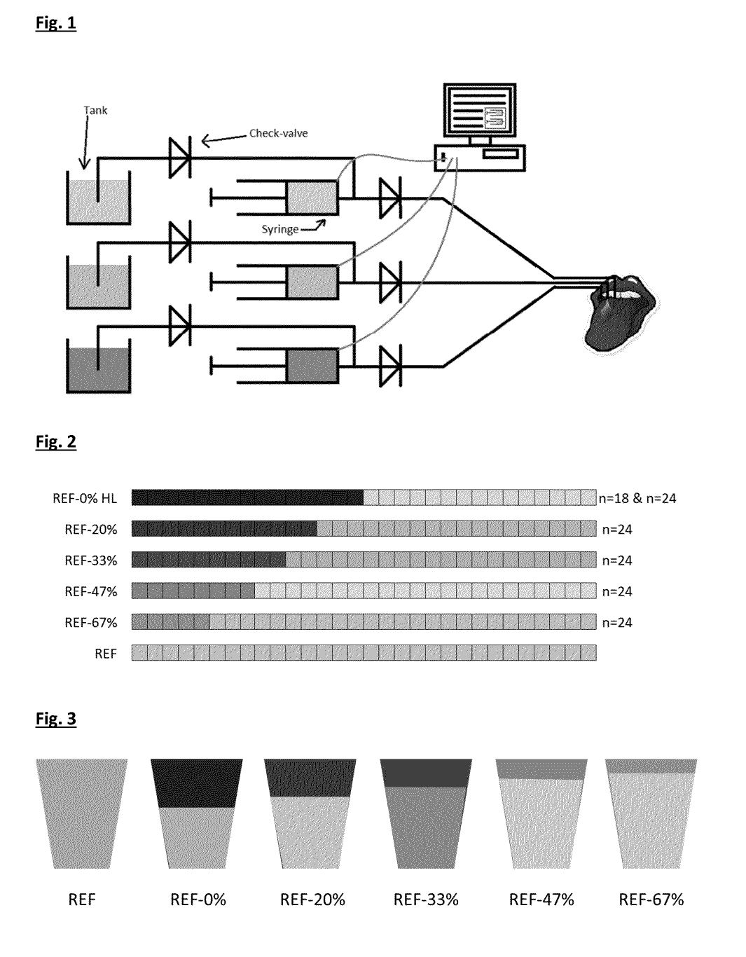

We used a custom built gustometer using high performance syringe pumps to deliver fluids to the assessor's mouth. The design of the gustometer ensures that the tastant concentration that reaches the assessor's mouth by not having any mixing of the fluids in the fluidic line of the device (see FIG. 1). This is achieved in practice by using a custom built mouthpiece with separate fluidic lines, covered by a commercially available drinking straw, this step allows for the fluids not to be mixed before entering the mouth, thus minimizing potential mixing and diffusion of the solutes between successive stimuli, but the rest of the drinking process is not modified compared to natural drinking. Using this device, we were able to deliver several types of patterns, either delivering sodium at the start or at the end of the mouthful. It should be noted that the total experiment time is here around 3.75 s and is thus a very different time scale compared to the results available in the literature which are often on the scale of tens of seconds or minutes. The different patterns that can be delivered in this way are presented in FIG. 2. For each pattern the dark shading represents the delivery of 2% NaCl solution (in water, Aqua Panna) and the light shading 0% NaCl solution (simply water, Aqua Panna), The first pattern contains exactly the same amount of NaCl as the reference pattern, at the bottom of this same figure, which is a homogeneous 1% NaCl solution (in water, Aqua Panna). The other profiles were attempts to gradually reduce the amount of sodium chloride delivered by reducing the time (and proportionally the volume) of the concentrated tastant-containing solution and reciprocally increasing the time (and proportionally the volume) of the non tastant-containing solution. The corresponding reduction in NaCl compared to the REF are 20, 33, 47 and 67%.

The untrained assessors were presented sequentially each pattern accompanied by the reference sample, in randomized order to remove any bias linked to the order. There were two levels of randomization that was taken into account: pair of pattern randomized across subjects, and within each subject the reference sample presented in the first or second position.

One second after the end of the delivery, the assessors had to decide which of the two samples was the most intense in saltiness intensity (two alternative forced choice (2-AFC) method). The number of assessors was n=24 for the REF-20%, REF-33%, REF-47% and REF-67% samples. The REF-0% sample was repeated twice with two groups of assessors with n=18 and n=24 respectively. We define as ψ(s) the percentage of assessors that judged the sample as more intense than the reference homogeneous sample. Binomial distribution has been used in order to assess if the probability of choosing a pattern over the reference sample was significantly different from chance. Parameters of the binomial involve the number of subjects (n=24 or n=18); the probability (p=0.5), and the level of confidence (set up at α=0.05). We concluded that the patterns were perceived significantly more intense than the homogeneous REF if ψ(s)≥k/n where k is the threshold for significance defined as 1−P(X≥k)≤α, X˜Bi(n,p).

The study was designed to identify whether delivering the tastants at the start of a sip would constitute an improvement in taste perception compared to the delivery of the tastant in a monotonous fashion.

To confirm that those effects could be transferred into a real food system, we designed an additional study where tomato soup was served to untrained assessors where all the NaCl was concentrated at the start of a sip (top of the cup) similarly to the gustometer experiment. The soup was served in 20 ml transparent cups normally used for sensory analysis. The soups were always proposed in pairs in randomized order with one being heterogeneously distributed in NaCl, by careful deposition (using a pipette) of one layer on top of another, and the other one being homogeneously distributed in NaCl at 0.7% acting as a reference (see FIG. 3). Similarly to the gustometer experiment, we gradually reduced the volume of the concentrated (tastant-containing) layer ([NaCl]=1.4%) and increased the volume of the non tastant-containing layer ([NaCl]=0%) in order to propose NaCl reductions between 0 and 67%. For the sake of simplicity, we name those samples exactly as the pattern delivered with the gustometer, that provide the same NaCl reduction based on the same physical principle, their composition is detailed in table 1. The assessors (n=23) were instructed to drink the cups fully in one shot. We define as ψ_{c}(s) the percentage of assessors that judged the sample as more intense than the reference homogeneous sample. Binomial distribution has been used in order to assess if the probability of choosing a pattern over the reference sample was significantly different from chance. Parameters of the binomial involve the number of subjects (n=23); the probability (p=0.5), and the level of confidence (set up at α=0.95). We concluded that the heterogeneous samples were perceived significantly more intense than the homogeneous REF if ψ_{c}(s)≥k/n where k is the threshold for significance defined as 1−P(X≥k)≤α, X˜Bi(n,p).

TABLE 1
Composition of the tomato soup samples

| | | Volume of | Volume of non |
|---|---|---|---|
| | Sodium reduction | concentrated | tasting bottom layer |
| Sample | compared to ref [%] | top layer [ml] | [ml] |
| Ref-0% | 0 | 10 | 10 |
| Ref-20% | 20 | 8 | 12 |
| Ref-33% | 33 | 6.6 | 13.4 |
| Ref-47% | 47 | 5.3 | 14.7 |
| Ref-67% | 67 | 3.3 | 16.7 |

### 1.b Results

The results show that the initial sodium content delivered to the mouth during a sip is driving the final choice of the assessor in terms of intensity. Using the gustometer we found that REF-0% and REF-20% were perceived significantly more intense than the reference sample (significance threshold is 67%), in spite of the fact that REF-20% contains 20% less NaCl. For REF-0%, the measurements were repeated twice with n=18 and n=24 and we obtained ψ(REF−0%)₁=77% and ψ(REF−0%)₂=83%, respectively, showing the good reproducibility of the task. REF-33% is exactly at the level of significance to be perceived more intense than the REF. REF-47% is also perceived more intense, although not significantly, than the reference sample. Finally, REF-67% was perceived significantly less intense than the reference (significance threshold at 33%).

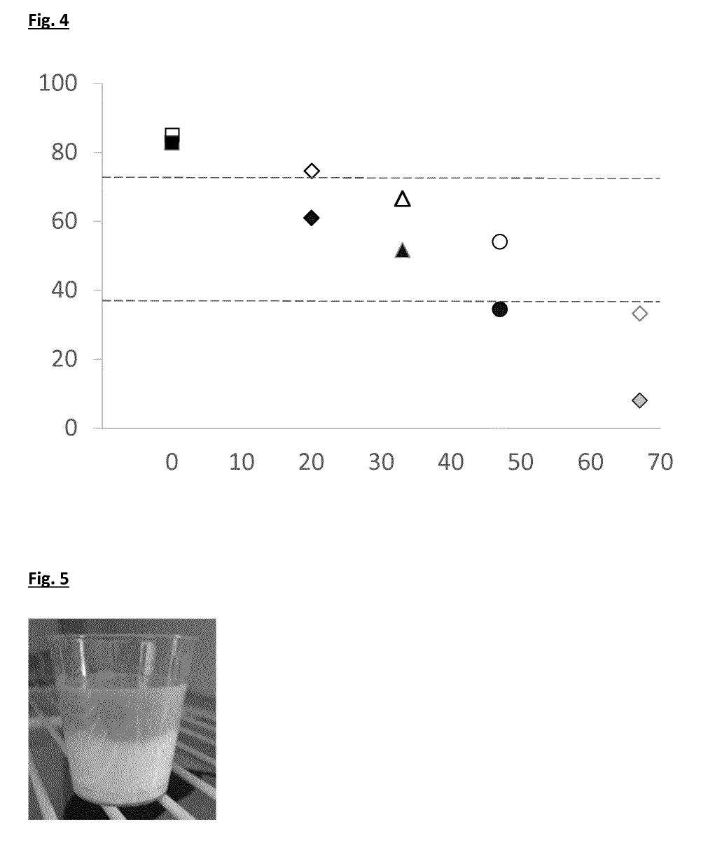

Similarly, we found using the layered cups that ψ_{c}(REF−0%)=82%, which demonstrates that this approach of delivering initial high intensity taste via a high concentration layer at the top of the cup flowing first on the tongue and its taste receptors yields similar results to the gustometer. However we also report that this effect observed with the gustometer holds also for the other samples produced in the cups, except that the values of ψ_{c} are always lower than corresponding values of ψ_{c} as shown in FIG. 4. This can possibly be explained by the some mixing that may have occurred both during the preparation of the samples or during their consumption, making the pattern less effective.

### Example 2: Sensory Impact of Beverage with Two Portions, One Containing Sugar

A group of 15 tasters were presented with two milk-based drinks in a pair comparison test and asked to identify the sweeter sample. They were then asked to rate how confident they were in their choice by selecting “absolutely sure”, fairly sure”, “not very sure” or “just guessed”.

The two drinks contained the same quantity of sucrose overall (10%), but whereas the reference (REF) was a homogeneous drink containing 10% sucrose, the test sample had a first homogeneous layer containing no sucrose (Sol_0) and a second homogeneous layer on top (Sol_20) containing 20% sucrose. The test sample contained 10 g of each of Sol_0 and Sol_20, to match the reference of 20 g. The volume of the second layer being 50% of the total beverage volume. The drinks were presented in tasting cups. In a preliminary test, a cup was made up with colouring in the top (Sol_20) layer (see FIG. 5). When this cup was drunk from in the usual way, a combination of both layers entered the taster's mouth with the top layer entering the mouth first. For the actual taste tests, no colour was used. The samples presented to the tasters had two visually identical layers. The tasters were instructed to drink the contents of the cup in one go.

| | | | Concentration |
|---|---|---|---|
| | Sugar reduction | Concentration of the | of the bottom |
| Sample | compared to ref [%] | top 10 ml layer [%] | 10 ml layer [%] |
| REF | N/A | 10 | 10 |
| Test | 0 | 20 | 0 |

Fourteen of the fifteen tasters identified the two layered test sample as being the sweeter sample. Twelve were absolutely sure, one was fairly sure and one was not very sure. This demonstrates that a beverage with two portions consumed together is perceived as more sweet (p<0.0001) if it has all the sugar is in the top portion compared with a beverage containing the same amount of sugar distributed evenly throughout the beverage.

1. Beverage comprising a first homogeneous portion, and a second homogeneous portion being visually the same as the first portion, wherein a tastant is present in the second portion, the tastant being essentially absent from the first portion, and wherein the volume of the second portion is between 10% and 60% of the total volume of the beverage and wherein part of the first portion and part of the second portion are consumable together.

2. A beverage according to claim 1 wherein the first and second portions are layers of the beverage and wherein the second portion is the top layer of the beverage.

3. A beverage according to claim 1 wherein the tastant comprises sodium chloride.

4. A beverage according to claim 1 wherein the beverage contains 140 mg of sodium or less per 100 g of the total beverage.

5. A beverage according to claim 1 wherein the tastant comprises sucrose.

6. A beverage according to claim 1 wherein the beverage type is selected from the group consisting of soups, drinking yoghurts, coffee, tea, drinking chocolates and malt beverages.

7. A kit comprising a first beverage capsule and a second beverage capsule both containing a powdered beverage composition and being adapted to be functionally inserted in the brewing cavity of a food preparation machine for the preparation of a beverage, the powdered beverage contained within the second capsule comprising a tastant, the tastant being essentially absent from the powdered beverage composition of the first portion, but otherwise the two powdered beverage compositions having essentially the same composition.

8. A kit according to claim 7 wherein the powdered beverage composition is selected from the group consisting of tea, coffee, drinking chocolate or malt beverage and wherein the tastant is a sweet tastant.

9. A kit according to claim 7 wherein the powdered beverage composition is soup and the tastant is a salty tastant.

10. Process for preparing a beverage, the process comprising
delivering a first beverage portion into a receptacle;
delivering a second beverage portion comprising a tastant into the receptacle such that the second beverage portion forms a layer on top of the first beverage portion;
wherein the tastant is homogeneously distributed in the second beverage portion and the tastant is essentially absent from the first beverage portion, the first beverage portion being visually the same as the second beverage portion; and
wherein the volume of the second beverage portion is between 10% and 60% of the total volume of the beverage.

11. A process according to claim 10 wherein the process is performed by a food preparation machine.

12. A process according to claim 10 wherein the first and second beverage portions are selected from the group consisting of tea, coffee, drinking chocolate and malt beverage and wherein the tastant is a sweet tastant.

13. A process according to claim 10 wherein the first and second beverage portions are soup and wherein the tastant is a salty tastant.

14-15. (canceled)
